(19) United States
(12) Patent Application Publication
(10) Pub. No.: US 2026/0318206 A1
(43) Pub. Date: Oct. 15, 2026

(54) GEOLOGICAL ADVANCED DETECTION METHOD AND SYSTEM FOR HIGH-TEMPERATURE HEAT DAMAGE IN TUNNELS BASED ON THERMAL SOURCE INVERSION

(71) Applicant: SHANDONG UNIVERSITY, Jinan (CN)

(72) Inventors: Bin LIU, Jinan (CN); Zhengyu LIU, Jinan (CN); Chengkun WANG, Jinan (CN); Yuxiao REN, Jinan (CN); Peng BAI, Jinan (CN)

(21) Appl. No.: 19/685,205

(22) Filed: May 22, 2026

Related U.S. Application Data
(63) Continuation of application No. PCT/CN2023/140807, filed on Dec. 22, 2023.

(30) Foreign Application Priority Data
Nov. 24, 2023 (CN) 2023115863741

(51) Int. Cl. E21F 17/18

(52) U.S. Cl. CPC E21F 17/18

(57) ABSTRACT

A geological advance detection method and system for high-temperature heat damage in tunnels based on thermal source inversion. The geological advance detection method may include: collecting temperature data by using a “rock wall+borehole” multi-view joint observation; extracting collected two-type temperature data to form a new sequence; performing inversion interpretation on the sequence; constructing a thermal source inversion objective function and an inversion equation to solve the inversion equation; based on the solution results, forming a thermal source and temperature field image for high-temperature heat damage detection within the survey area; and, according to the thermal source and temperature field image, a cooling execution scheme is generated by a targeted cooling system to form a closed-loop cooling control and ensures safety of tunnel construction.

### CROSS-REFERENCE TO RELATED APPLICATIONS

The present invention claims the benefit of priority to Chinese Patent Application No. 202311586374.1, entitled “GEOLOGICAL ADVANCED DETECTION METHOD AND SYSTEM FOR HIGH-TEMPERATURE HEAT DAMAGE IN TUNNELS BASED ON THERMAL SOURCE INVERSION”, filed on Nov. 24, 2023, with the China National Intellectual Property Administration, the entire contents of which are incorporated herein by reference and form a part of the present invention for all purposes.

### TECHNICAL FIELD

The present invention relates to the technical field of tunnel geothermal field detection, in particular to a geological advance detection method and system for high-temperature heat damage in tunnels based on thermal source inversion.

### BACKGROUND

The statements in this section merely provide background information related to the present invention and do not necessarily constitute prior art.

In certain regions, high altitudes, diverse terrains, complex geological conditions, abundant geothermal resources, and frequent hydrothermal activities are common. Hot springs and geothermal waters are widely distributed. Tunnel projects traversing high ground temperature regions are constantly emerging, and high ground temperature has become one of the significant challenges in tunnel construction. High-temperature heat damages caused by geothermal anomalies significantly impact tunnel engineering, especially the construction of deep and long tunnels. High ground temperature not only increases the difficulty of tunnel construction and extends the construction period, reducing economic benefits, but also endangers the health of construction personnel and the safety of structures. Specific problems include the following:

(1) In a high-temperature environment, the working efficiency of mechanical equipment and workers decreases, and equipment failures increase. Working long hours under high ground temperature conditions can lead to heat-related illnesses such as heat cramps, heat exhaustion, and heat stroke, severely endangering the physical and mental health of workers and endangering the safety and quality of the project.

(2) High ground temperature not only affects the construction machinery and personnel inside the tunnel but also impacts the surrounding rock and the structure of the tunnel itself. Because the temperature of the rock in high geothermal tunnels is high, while the air temperature inside the tunnel is relatively low, a temperature differential is generated on the lining structure. This temperature differential induces a non-uniform stress distribution, resulting in tensile stress on the surface of the concrete structure. Due to the weak tensile performance of concrete structures, this constitutes a potential heat damage to tunnel structural safety.

Therefore, during tunnel construction, effective advance geological detection methods must be adopted. These methods detect the location and scale of high-temperature heat damages ahead, assess the type and level of the heat damages, and support the formulation and implementation of effective countermeasures.

Tunnel high-temperature heat damages are classified into high rock temperature and high-temperature geothermal water. In existing engineering construction, advance horizontal drilling methods are often used to predict whether there is geothermal water or geothermal steam ahead. Temperature is measured within the boreholes to obtain rock temperature or geothermal water temperature, thereby determining the type and level of thermal heat damage to guide and ensure construction safety. However, high-temperature geothermal water in tunnels mostly develops in the forms of fault-hard rock fissures or fault-karst dissolution fissures, conduits, and caves, with complex and diverse occurrence conditions. Moreover, the temperature field is a diffusion field, and the transfer range of small-volume thermal sources is limited. Relying solely on borehole temperature measurement methods makes it difficult to detect the distribution of concealed high-temperature geothermal water around the borehole, leading to significant rates of missed detection.

Therefore, there is a need to propose an advance geological detection method and system based on thermal source inversion for high-temperature heat damages in tunnels. The method and system invert the detection results to obtain the distribution of the surrounding rock geothermal field ahead of the tunnel face, thereby enabling effective locating and identifying of thermal sources. Based on the information of the localized and identified sources, effective countermeasures can be formulated and implemented, and a cooling system within the tunnel can be guided or controlled to achieve targeted and precise management of the heat damages.

### SUMMARY

According to some examples, the present invention adopts the following solutions.

A geological advance detection method for high-temperature heat damage in tunnels based on thermal source inversion, comprising the following steps:
preliminarily determining high-temperature anomalous sections along the tunnel based on preliminary geological survey data of the tunnel and high ground temperature monitoring data within the tunnel;
arranging advance boreholes in the preliminarily determined high-temperature anomalous sections, deploying temperature measuring equipment in the advance boreholes, and measuring and collecting internal rock mass temperatures;
scanning tunnel surrounding rock to collect apparent temperature of the tunnel surrounding rock and measurement spatial data;
extracting the internal rock mass temperatures, the apparent temperature of the tunnel surrounding rock, and the spatial data to construct an inversion sequence;
constructing a three-dimensional (3D) thermal source inversion objective function and an inversion equation based on a least squares method, and solving the inversion equation using the inversion sequence;
based on the solution results, imaging the thermal source distribution and temperature field for high-temperature heat damage detection within the survey area and combining the imaging results with the geology of the excavated tunnel section to analyze parameters of the high-temperature heat damage, including: core temperature value, thermal source spatial position coordinates, thermal source distribution scale, heat damage type, and heat damage level, to generate optimal cooling control parameters; and
inputting the optimal cooling control parameters into a tunnel cooling execution unit and controlling variable frequency refrigeration system and spray system of the cooling execution unit to cool an interior of the tunnel; and, based on changes in at least one characteristic of the high-temperature heat damage, such as temperature, spatial position, scale, type, and level, maintaining a temperature of the interior of the tunnel within a human comfort zone.

As an optional implementation, the optimal cooling control parameters include but are not limited to modes, numbers of activations, pitch angles, horizontal deflection angles, and spray durations of nozzle sprays in the spray system.

As an optional implementation, the specific process of preliminarily determining high temperature anomalous sections along the tunnel includes: conducting geophysical prospecting and deep borehole temperature measurement on the ground surface along the tunnel excavation axis, delineating geothermal anomalous sections, and preliminarily determining the type of high-temperature heat damage. Inside the tunnel, high ground temperature monitoring is performed, including measurements of surrounding rock surface temperature, working environment temperature, and water temperature. Based on changes in temperature and a rate of temperature of the excavated sections along the tunnel, it is determined whether a high ground temperature anomalous area is being entered.

After tunnel excavation, a qualitative understanding of the temperature condition ahead of the tunnel can be obtained by routinely monitoring changes in surrounding rock temperature and the rate of temperature after excavation of the tunnel face. Generally, if the surrounding rock temperature exceeds a set temperature, and as tunnel excavation proceeds, the surrounding rock temperature continuously increases and the rate of temperature continuously increases, then it can be qualitatively determined that excavation is continuously approaching a high ground temperature anomalous area.

As an optional implementation, the specific process of arranging advance boreholes and arranging temperature measuring devices in the advance boreholes includes the following steps: excavating niches on the left- and right-side walls behind the tunnel face; drilling advance boreholes from the niches toward the front of the tunnel; installing distributed optical fiber into the boreholes; filling the boreholes with cement mortar; and, after the surrounding rock temperature and the temperature inside the boreholes reach stability, collecting and analyzing temperature data inside the boreholes.

As an optional implementation, the specific process of obtaining scanning results of the apparent temperature of the tunnel surrounding rock includes the following steps: performing mobile scanning of the temperature of the left-side wall, right-side wall, arch crown, and tunnel face, and matching the infrared temperature measurement results with the measurement space.

As an optional implementation, the objective function is specifically:

S_{MP}=(ΔT−J(F−F₀))^{T}(ΔT−J(F−F₀))+λ(C(F−F₀))^{T}(C(F−F₀))+η(W₁(F−Fᵣ))^{T}(W₁(F−Fᵣ));
wherein, ΔT is a difference vector between actual observed data and forward theoretical observed data; F is a model parameter vector to be solved in inversion; J is a sensitivity matrix; C is a smoothness matrix; λ is a Lagrange constant for controlling a weight between a data variance term and a model variance term; F₀ is a model parameter obtained from a previous inversion solution; Fᵣ is a reference model parameter vector for a current inversion; W₁ is a reference model coefficient matrix; η is a weight coefficient of a reference model constraint.

As an optional implementation, the inversion equation is:

$$( {J}^{T} J + λ {C}^{T} C + η {W}_{1}^{T} {W}_{1} ) Δ F = {J}^{T} Δ F - η {W}_{1}^{T} {W}_{1} ( {F}_{0} - {F}_{r} ) ;$$

wherein, ΔF is an increment vector of model parameters. J is a sensitivity matrix. C is a smoothness matrix. λ is a Lagrange constant. Fᵣ is a reference model parameter vector for a current inversion. W₁ is a reference model coefficient matrix. η is a weight coefficient of a reference model constraint.

Wherein, the sensitivity matrix J is

J=K⁻¹;
wherein, K is formed by accumulation of thermal conductivity on discrete nodes of the objects contained in each element, and is a known quantity.

As an optional implementation, the specific process of solving the inversion equation includes:
establishing a finite difference model for 3D thermal load model parameters and determining initial values of model parameters based on measured temperature data;
performing geological analysis and geophysical prospecting, determining prior information of anomalous bodies and mapping the prior information to the inversion calculation model to form a reference model;
for given model parameters, simulation calculations are performed using a finite difference method to obtain theoretical observed data;
performing a convergence judgment of the inversion based on a mean square error between measured data and theoretical data as a criterion; if the mean square error obtained by inversion is less than a set convergence value or a set number of inversions is reached, the inversion is terminated, outputting the model parameters obtained at that point, and obtaining a temperature distribution by performing forward calculation on the model parameters; and, if the mean square error is greater than the set convergence value and the set number of inversions has not been reached, the inversion steps are continued;
then, based on the reference model constraint and the model parameters in the current inversion, solving the inversion equation to obtain the model parameter vector change;
and then, obtaining new model parameters and returning to the step of using the finite difference method for simulation calculation to perform a next generation iterative inversion.

A geological advance detection system for high-temperature heat damage in tunnels based on thermal source inversion, including:
a first acquisition system configured to measure a rock mass internal temperature in advance boreholes arranged in preliminarily determined high temperature anomalous sections;
a second acquisition system configured to obtain scanning results of an apparent temperature of a tunnel surrounding rock;
an inversion interpretation module configured to extract the two collected temperature data to form a new sequence, perform an inversion interpretation on the sequence, construct a 3D thermal source inversion objective function based on a least squares method and an inversion equation, and solve the inversion equation;
an imaging analysis module configured to form, based on the solution of the inversion equation, a thermal source and temperature field image for high-temperature heat damage detection within a survey area, and combine with geology information to analyze a temperature, a location, a scale, a type, and a heat damage level of the high-temperature heat damage;
a targeted cooling module configured to generate a cooling execution scheme based on the parameters of the high-temperature heat damage, dynamically adjust the cooling execution scheme based on feedback data during a cooling operation, and form a closed-loop cooling control.

As an optional implementation, the first acquisition system includes a plurality of distributed optical fiber temperature measurement modules, each arranged in the advance borehole. The second acquisition system is provided as a scanning robot.

Compared with the prior art, the beneficial effects of the present invention are:

The present invention provides the method for advance geological detection of the high-temperature heat damage in tunnels based on thermal source inversion. Using tunnel rock wall apparent temperature and borehole temperature, the thermal source is inverted and the temperature field inside the surrounding rock ahead of the tunnel is reconstructed. In this manner, effective locating and identifying of the thermal source are achieved. The high-temperature heat damage level is then classified according to the temperature distribution, and the risk of the high-temperature heat damage is evaluated. Thus, technical guidance is provided for early warning and treatment of high-temperature heat damages.

The present invention proposes a “rock wall+borehole” multi-view joint observation system. A rock wall temperature field scanning robot is used to achieve rapid sensing of the apparent temperature of surrounding rock. The borehole distributed optical fiber temperature measurement device is used to sense an internal temperature distribution of the rock mass, obtaining effective geological information and improving the detection and identification capability for high-temperature heat damage anomalies.

The present invention constructs the ground temperature field constrained inversion equation carrying the prior reference model, adding the prior information obtained by other geophysical methods, which makes the thermal source parameters of the model develop toward the reference model determined by the prior information. Theoretically, it helps suppress a multi-solution problem of the inversion. The method achieves a good representation of a shape, a scale, a temperature, etc. of the thermal source.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of a distributed optical fiber temperature measurement arrangement in a tunnel borehole according to the present invention.

FIG. 2 is a schematic diagram of a tunnel rock wall infrared temperature measurement arrangement according to the present invention.

FIG. 3A is a numerical example model of a high-temperature heat damage distribution according to the present invention.

FIG. 3B is a distribution diagram of a thermal source and a temperature field obtained by an inversion according to the present invention.

FIG. 4 is a schematic diagram of a targeted cooling system arrangement according to the present invention.

FIG. 5 is a flow chart of an advance geological detection method for a high-temperature heat damage according to the present invention.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, the terms “comprise” and/or “include” used in this specification indicate that there are features, steps, operations, devices, components, and/or combinations thereof.

A geological advance detection method for high-temperature heat damage in tunnels based on thermal source inversion, as shown in FIG. 5, includes the following steps:

Step A: based on surface preliminary survey and borehole temperature measurement, delineating geothermal anomalous sections from a macro perspective; based on high ground temperature monitoring data inside the tunnel, analyzing anomalous changes in a rate of temperature of excavated sections, and predicting areas about to encounter high ground temperature heat damages from an engineering perspective; designing a scientific and reasonable borehole layout scheme in the prediction section.

In the present example, as shown in FIG. 1, niches are excavated in side walls about 2 meters behind a tunnel. advance boreholes are drilled from the niches toward the front of the tunnel, as parallel to a tunnel axis as possible.

In some typical examples, the advance boreholes may be multiple.

Step B: installing a distributed optical fiber into two advance boreholes and filling the boreholes with a cement mortar to equilibrate a temperature inside the boreholes with a surrounding rock temperature. Because it takes a long time to reach thermal equilibrium, the niche and advance borehole layout scheme is designed. Thereafter, temperature measurement data obtained by the distributed optical fiber in the boreholes are collected and analyzed to preliminarily determine a location of the thermal source.

Step C: using a thermal infrared scanning robot to perform a mobile scanning of the temperature of a left-side wall, a right-side wall, an arch crown, and a tunnel face. The thermal infrared scanning robot has a built-in positioning system. The infrared temperature measurement results are matched with measurement space to obtain a large amount of apparent temperature of a tunnel rock wall.

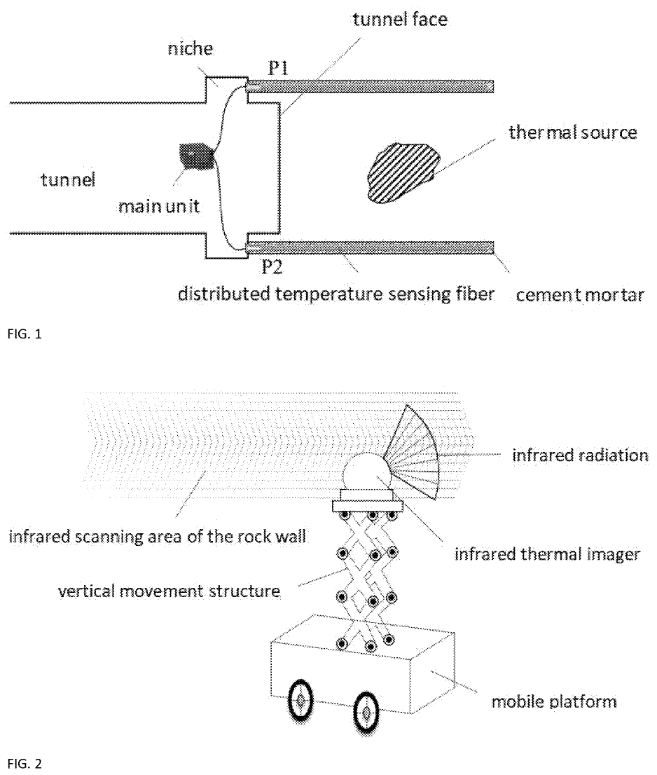

The thermal infrared scanning robot may be provided as an existing robot. As shown in FIG. 2, an example of a feasible thermal infrared scanning robot structure is given. It specifically includes a traveling mechanism. A vertical movement structure is provided on the traveling mechanism. An infrared thermal imager is provided on the vertical movement structure. By adjusting a position of the traveling mechanism and a position of the vertical movement structure, an infrared scanning of various points on the rock wall is achieved.

Step D: obtaining a new “borehole+rock wall” multi-view joint observation mode by combining steps B with C. The data collected by the observation mode are extracted to form a new sequence and a comprehensive inversion interpretation on the sequence is performed. This greatly increases an amount of collected data to obtain effective geological information ahead of the tunnel and improves a detection and identification capability for high-temperature heat damage anomalies ahead of the tunnel.

In the present example, the extraction of the new sequence depends on a preset grid size. All extracted temperature points must be located on grid nodes. The rock wall and the borehole temperature data may be arranged in any order, provided that the resulting sequence matches the forward and inversion process. The extracted temperature data are then used to invert the thermal source distribution ahead of the tunnel.

Step E: to address a multi-solution problem in the 3D thermal source inversion image of the tunnel, the present invention proposes a ground temperature field constrained inversion approach with a prior reference model. An objective function for a 3D thermal source detection inversion is:

S_{MP}=(ΔT−J(F−F₀))^{T}(ΔT−J(F−F₀))+λ(C(F−F₀))^{T}(C(F−F₀))+η(W₁(F−Fᵣ))^{T}(W₁(F−Fᵣ)); (1)
wherein, ΔT is a difference vector between actual observed data and forward theoretical observed data; F is a model parameter vector to be solved in the inversion; J is a sensitivity matrix; C is a smoothness matrix; λ is a Lagrange constant for controlling a weight between a data variance term and a model variance term; Fᵣ is a reference model parameter vector for a current inversion; W₁ is a reference model coefficient matrix; η is a weight coefficient of a reference model constraint.

Minimizing the objective function (1) to obtain a corresponding inversion equation:

$$( {J}^{T} J + λ {C}^{T} C + η {W}_{1}^{T} {W}_{1} ) Δ F = {J}^{T} Δ F - η {W}_{1}^{T} {W}_{1} ( {F}_{0} - {F}_{r} ) . \qquad ( 2 )$$

The above formula is the ground temperature field constrained inversion equation with a prior reference model. Theoretically, prior information obtained by other geophysical methods is applied as a constraint to the inversion equation. This makes the thermal source parameters of the model develop toward the reference model determined by the prior information. It helps suppress the multi-solution problem of the inversion, achieving a good representation of a shape, a scale, a temperature value, etc. of the thermal source.

Step F: in a process of the 3D thermal source inversion, the sensitivity matrix J is different from conventional calculation methods. Its calculation expression is as follows:

J=K⁻¹; (3)
wherein, K is formed by accumulation of thermal conductivity on discrete nodes of objects contained in each element. In form, K is symmetric and invertible, and is a known quantity.

A specific calculation flow of the thermal source inversion is as follows:
(1) A finite difference model for 3D thermal load model parameters is established. Initial values of the model parameters are determined based on the measured temperature data.
(2) A geological analysis and geophysical prospecting are performed, determining prior information of an anomalous body and mapping the prior information to the inversion calculation model to form the reference model.
(3) For the given model parameters, a finite difference method is used to perform simulation calculations to obtain theoretical observed data.
(4) A convergence judgment of the inversion is performed using a mean square error between measured data and theoretical data as a criterion. If the mean square error obtained by the inversion is less than a set convergence value, or if a set number of inversions is reached, the inversion is terminated and output the model parameters obtained at that point. A temperature distribution is obtained by a forward calculation. If the mean square error is greater than the set convergence value and the set number of inversions has not been reached, the inversion steps are continued.
(5) Based on the reference model constraint and the model parameters in the current inversion, the inversion equation is solved to obtain a model parameter vector change ΔF.
(6) New model parameters are obtained. The process goes to step (3) to perform a next generation iterative inversion.

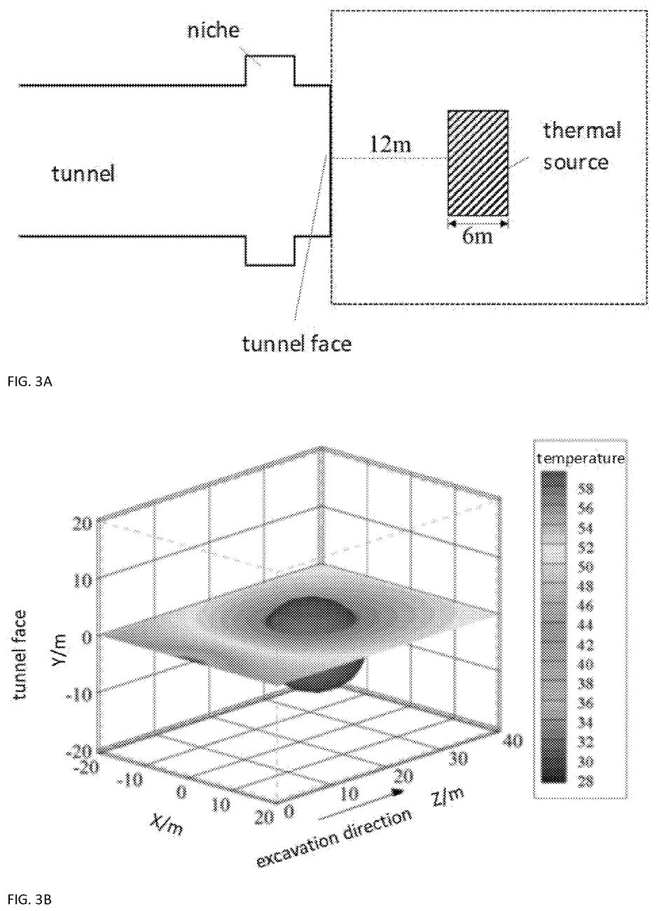

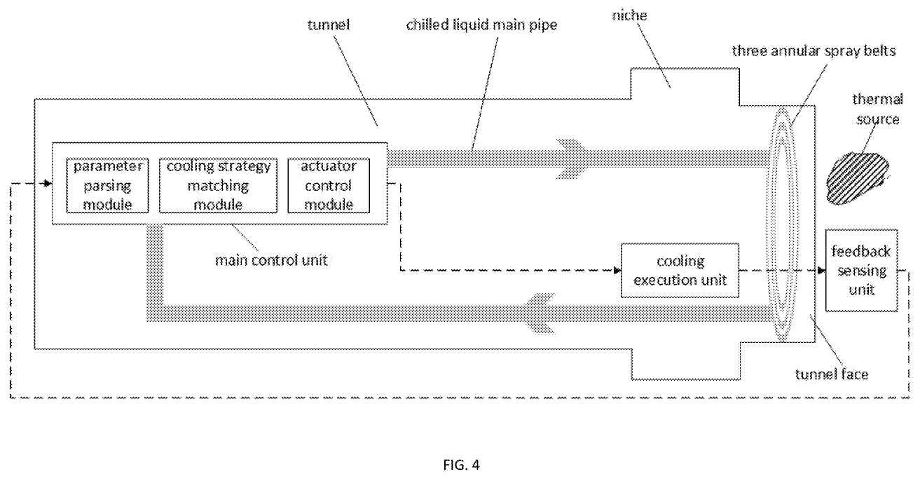

Step G: after the above steps, the collected temperature data are inverted and interpreted to obtain the thermal source inversion image for the high temperature geothermal anomalies within a survey area. FIG. 3A shows a numerical example model of the thermal source distribution. FIG. 3B is a thermal source and temperature field isosurface diagram obtained by the comprehensive inversion interpretation using the method of the present invention. A position, a shape, and a scale of the thermal source can be clearly seen from the figure, which are basically consistent with an original model.

Through the 3D thermal source detection, an accurate thermal source distribution temperature field image in the tunnel can be obtained. Combined with existing geological analysis, the type of the high-temperature heat damage and the heat damage level to the tunnel can be further inferred, providing technical support for safe and efficient construction of the high ground temperature tunnel.

Step H: based on a gradient change of the 3D ground temperature field distribution obtained by the inversion, the type of the heat damage ahead of the tunnel can be determined. Generally, if a lateral temperature change is small, no thermal water is exposed, and if the temperature from ground drilling shows a multi-segment broken line, the heat damage can be determined as a conductive heat damage. If the temperature change is large, the thermal water is exposed, and the temperature from ground drilling shows an upward convex shape, the heat damage can be determined as a convective heat damage, i.e., high temperature water.

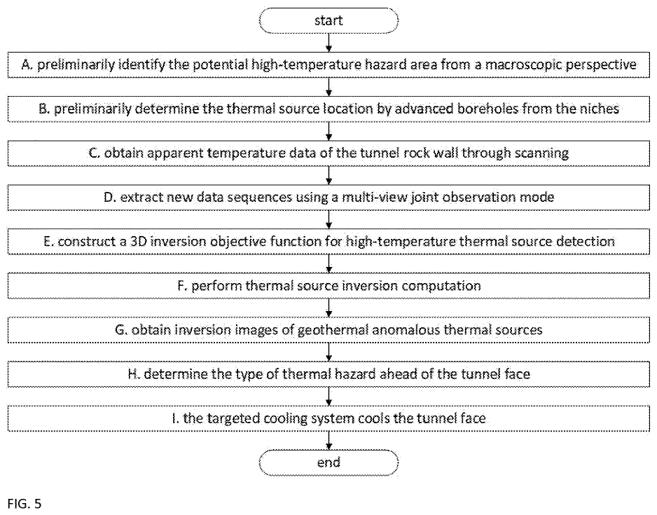

Step I: based on the results obtained from the inversion, including the thermal source distribution temperature field result diagram, the type of the heat damage ahead of the tunnel, and the heat damage level to the tunnel, the present example adopts a layout of “fixed cold source+mobile terminals”. A targeted cooling system for the tunnel high-temperature heat damage is arranged in the tunnel. The targeted cooling system includes a main control unit, a cooling execution unit, and a feedback sensing unit. FIG. 4 is a schematic diagram of an arrangement of the targeted cooling system according to the present invention.

The main control unit is provided with standardized wired/wireless communication interfaces. It is directly communicatively connected to an imaging analysis module of the advance geological detection system. The communication interface is configured to receive the high-temperature heat damage parameters output by the imaging analysis module. The parameters include five core parameters: a core temperature value T_{core} of the high-temperature heat damage, thermal source spatial position coordinates P(x_{c}, y_{c}, z_{c}), a thermal source distribution scale R, a heat damage type D_{type}, and a heat damage level G. The main control unit has a built-in parameter parsing module, a cooling strategy matching module, and an actuator control module. The main control unit can automatically generate a cooling execution scheme based on input parameters and can perform fully automated cooling control.

The cooling execution unit is electrically connected to the actuator control module of the main control unit, including a variable frequency refrigeration unit fixedly installed in an equipment cavern and a spray head array installed on a movable support.

The variable frequency refrigeration unit includes a compressor, a condenser, and a chilled water tank. The variable frequency refrigeration is fixedly installed in an equipment cavern 50 meters to 200 meters behind a tunnel face. It supplies a low-temperature coolant to the tunnel face through a high-pressure chilled liquid main pipe laid on a tunnel floor;

The spray head array is installed on a movable support 0.5 meters to 5 meters from the tunnel face. The support is preferably fixed on a protective frame of a tunnel excavation jumbo, moving forward and backward with the jumbo. The support is provided with three annular spray belts according to relative positions to the tunnel face: an arch crown spray belt, a left-side wall spray belt, and a right-side wall spray belt. Each spray belt consists of 5 to 10 high-pressure spray heads arranged in a matrix;

Each spray head is equipped with a micro-mist nozzle for generating an ultra-fine water mist and a direct water nozzle for a direct water jet impact. The spray heads are respectively connected via solenoid valves to a high-pressure micro-mist pump and a high-flow centrifugal pump. Inlets of the high-pressure micro-mist pump and the high-flow centrifugal pump are both connected to an outlet of the chilled water tank. The low-temperature coolant is used for cooling;

Each spray head is connected to a micro servo motor. The actuator control module of the main control unit controls opening and closing of the solenoid valves based on the received heat damage type parameter D_{type}, switching between a micro-mist mode or a direct water mode. At the same time, the micro servo motors adjust a pitch angle θ and a horizontal deflection angle φ of the spray heads, achieving a dual dynamic adjustment of a spray direction and a spray mode.

Preferably, the spray head array adopts a modular mixed arrangement. Some spray heads are only equipped with the micro-mist nozzles. Some spray heads are only equipped with the direct water nozzles. Some spray heads are equipped with dual-mode nozzles. The main control unit selectively activates a corresponding type of a spray head group based on the heat damage type D_{type}. For example, for the conductive heat damage, only the micro-mist nozzles and a micro-mist path of the dual-mode nozzles are activated. For the convective heat damage, only the direct water nozzles and a direct water path of the dual-mode nozzles are activated, and at the same time the servo motors adjust the pitch angle θ and the horizontal deflection angle φ of the spray heads.

The feedback sensing unit includes distributed optical fiber temperature sensors, an infrared thermal imager, and an in-tunnel ambient temperature sensor, all electrically connected to the main control unit. The feedback sensing unit can collect feedback data in real time during the cooling operation, such as a rock mass internal temperature, a surrounding rock surface temperature, and a working environment temperature. The feedback sensing unit feeds back the data to the main control unit in real time. The main control unit can dynamically adjust the cooling execution scheme based on the feedback data, forming a closed-loop control.

A specific control process of the targeted cooling system for a tunnel high-temperature heat damage includes:
(1) The main control unit receives data sent by the imaging analysis module of the advance geological detection system through the standardized wired/wireless communication interface. The parameter parsing module parses out the core temperature value T_{core} of the high temperature source, the thermal source spatial position coordinates P(x_{c}, y_{c}, z_{c}), the thermal source distribution scale R, the heat damage type D_{type}, and the heat damage level G. The heat damage levels may include: Level I-low risk, Level II-medium risk, and Level III-high risk
(2) The cooling strategy matching module of the main control unit determines a spray belt and a nozzle number need to be activated based on the thermal source coordinates P(x_{c}, y_{c}, z_{c}) and the thermal source distribution scale R. If a horizontal lateral coordinate of the thermal source indicates that the thermal source is on a right side of a tunnel center line (e.g., x_{c}>0), the main control unit determines to cool the right-side wall and generates a control command to activate the right-side spray belt. If the horizontal lateral coordinate indicates that the thermal source is on a left side of the tunnel center line (e.g., x_{c}<0), the main control unit determines to cool the left-side wall and generates a control command to activate the left side spray belt. If the horizontal lateral coordinate indicates that the thermal source is on the tunnel center line, both left- and right-side spray belts are activated. If a vertical height coordinate (denoted as y_{c}) is greater than a preset threshold of a tunnel cross-section height (denoted as Hₜᵤₙₙₑₗ), for example y_{c}>0.8×Hₜᵤₙₙₑₗ, the controller determines that the thermal source is in the arch crown and generates a control command to activate the arch crown spray belt.
(3) Based on the thermal source distribution scale R, if R<5 m², only a single-layer directional spray head corresponding to the coordinates is activated. If 5 m²≤R≤20 m², all spray heads in a spray belt where the coordinates are located are activated (for example, if the thermal source is on the right-side wall, an entire right side spray belt is activated). If R>20 m², all three layers of spray heads (i.e., the arch crown, the left-side wall, and the right-side wall spray belts) are activated simultaneously to form an enveloping cooling. The actuator control module calculates the required pitch angle θ and the required horizontal deflection angle φ for each spray head based on the coordinate values, and drives the spray heads to rotate to a target angle via the micro servo motors, so that a spray direction faces a thermal source center.
(4) Based on the heat damage type D_{type}, the main control unit switches a physical working mode of the cooling execution unit. For the conductive heat damage (D_{type}=1), the actuator control module drives the solenoid valve to open the line connected to the high-pressure micro-mist pump, activates the micro-mist nozzles, and outputs the ultra-fine water mist with a particle size of 10 μm, forming a “cold air curtain” attached to the high temperature surrounding rock surface to suppress thermal radiation. For the convective heat damage (D_{type}=2), the actuator control module drives the solenoid valve to switch to the high-flow centrifugal pump and opens solid cone nozzles to form a dense water curtain.
(5) The actuator control module dynamically adjusts the spray output intensity and safety actions based on the received core temperature value T_{core} and the heat damage level G. When G is Level I and T_{core}<60° C., the currently selected pump set is controlled to operate intermittently, with the spray on-time accounting for 30% of the working cycle. When the heat damage level is Level II and 60° C.≤T_{core}≤90° C., the currently selected pump set is controlled to perform continuous spray, and an audible and visual alarm is activated. When the heat damage level is Level III or T_{core}>90° C., the selected pump set is controlled to operate at full power at 100% rated flow. At the same time, non-intrinsically safe power supplies in that area (such as lighting, fans) are automatically cut off, the power supply for the targeted cooling system is retained, the audible and visual alarm is triggered, an emergency signal is uploaded to the ground dispatch center, and an emergency evacuation warning is issued.
(6) During the operation of the targeted cooling system, the feedback sensing unit collects rock mass internal temperature, surrounding rock surface temperature, and working environment temperature in real time, and transmits them to the main control unit. The main control unit determines whether the measured cooling effect meets the set requirements. If the temperature drop is below a preset threshold (e.g., less than 2° C.) within a preset time window (e.g., 30 seconds), and the current heat damage type G is convective, the output pressure of the high-flow centrifugal pump is automatically increased. If the current heat damage type G is conductive, the duration of the micro-mist spray is extended. When the temperature at all monitoring points drops below a safety threshold (e.g., 25° C.) and remains for 5 minutes, the main control unit automatically reduces the spray intensity or enters a standby mode. If the feedback sensing unit detects that the spray does not cover the thermal source center, i.e., the deviation between the thermal source center coordinates P(x_{c}, y_{c}, z_{c}) and the spray coverage center exceeds a set threshold Δd, the main control unit recalculates θ and φ and drives the servo motors to fine-tune.

While the specific examples of the present invention have been described above in conjunction with the accompanying drawings, they do not limit the scope of protection of the present invention. Those skilled in the art should understand that various modifications or variations that can be made without creative effort based on the technical solution of the present invention are still within the scope of protection of the present invention.

1. A geological advance detection method for high-temperature heat damage in a tunnel based on thermal source inversion, comprising:
preliminarily determining high temperature anomalous sections along the tunnel based on preliminary survey data and high ground temperature monitoring data inside the tunnel;
in the preliminarily determined high temperature anomalous sections, arranging advance boreholes, arranging temperature measuring devices in the advance boreholes, and measuring rock mass internal temperature;
obtaining scanning results of apparent temperature of tunnel surrounding rock;
extracting the two collected temperature data to form a new sequence, performing inversion interpretation on the sequence, constructing a three-dimensional (3D) thermal source inversion objective function based on a least squares method and an inversion equation, and solving the inversion equation;
based on the solution results, forming a thermal source and temperature field image for high-temperature heat damage detection within a survey area, and combining with existing geology to analyze a temperature, a location, a scale, a type and a heat damage level of the high-temperature heat damage.

2. The geological advance detection method according to claim 1, wherein a specific process of preliminarily determining high temperature anomalous sections along the tunnel comprises:
conducting geophysical prospecting and deep borehole temperature measurement on ground surface along a tunnel excavation axis, delineating geothermal anomalous sections, and preliminarily determining the type of the high-temperature heat damage;
performing high ground temperature data monitoring of surrounding rock surface temperature, working environment temperature and water temperature inside the tunnel;
based on the temperature and the rate of temperature changes of the excavated sections along the tunnel, determining whether entering a high ground temperature anomalous area.

3. The geological advance detection method according to claim 2, wherein after tunnel excavation, monitoring the surrounding rock temperature and the rate of temperature changes after excavation of the tunnel face;
if the surrounding rock temperature exceeds a set temperature, and as tunnel excavation proceeds the surrounding rock temperature continuously increases and the rate of temperature continuously increases, qualitatively determining that the excavation is approaching the high ground temperature anomalous area.

4. The geological advance detection method according to claim 1, wherein the specific process of arranging advance boreholes and arranging temperature measuring devices in the advance boreholes comprises:
excavating niches on the left- and right-side walls behind the tunnel face, drilling advance boreholes from the niches toward the front of the tunnel, and installing distributed optical fiber in the boreholes, and filling the boreholes with cement mortar;
after the surrounding rock temperature and the temperature inside the boreholes reach stability, collecting and analyzing the temperature data inside the boreholes.

5. The geological advance detection method according to claim 1, wherein a specific process of obtaining scanning results of the apparent temperature of the tunnel surrounding rock comprises:
performing mobile scanning of temperatures of a left-side wall, a right-side wall, an arch crown, and a tunnel face; and
matching infrared temperature measurement results with a measurement space.

6. The method according to claim 1, wherein the objective function is:
S_{MP}=(ΔT−J(F−F₀))^{T}(ΔT−J(F−F₀))+λ(C(F−F₀))^{T}(C(F−F₀))+η(W₁(F−Fᵣ))^{T}(W₁(F−Fᵣ));
wherein, ΔT is a difference vector between actual observed data and forward theoretical observed data; F is a model parameter vector to be solved in the inversion; J is a sensitivity matrix; C is a smoothness matrix; λ is a Lagrange constant for controlling a weight between a data variance term and a model variance term; F₀ is a model parameter of a previous inversion solution; Fᵣ is a reference model parameter vector for the current inversion; W₁ is a reference model coefficient matrix; η is a weight coefficient of a reference model constraint.

7. The geological advance detection method according to claim 1, wherein the inversion equation is:
$$( {J}^{T} J + λ {C}^{T} C + η {W}_{1}^{T} {W}_{1} ) Δ F = {J}^{T} Δ F - η {W}_{1}^{T} {W}_{1} ( {F}_{0} - {F}_{r} ) ;$$
wherein, ΔF is an increment vector of model parameters; J is a sensitivity matrix; C is a smoothness matrix; λ is a Lagrange constant; Fᵣ is a reference model parameter vector for a current inversion; W₁ is a reference model coefficient matrix; η is a weight coefficient of a reference model constraint;
wherein, the sensitivity matrix J is:
J=K⁻¹;
wherein, K is formed by accumulation of thermal conductivity on discrete nodes of the objects contained in each element, and is a known quantity.

8. The geological advance detection method according to claim 1, wherein a specific process of solving the inversion equation comprises:
establishing a finite difference model for 3D thermal load model parameters, determining initial values of model parameters based on the measured temperature data;
performing geological analysis and geophysical prospecting, determining prior information of anomalous bodies, mapping the prior information to the inversion calculation model to form a reference model;
for given model parameters, using a finite difference method to perform simulation calculations to obtain theoretical observed data;
performing an inversion convergence judgment, using a mean square error between measured data and theoretical data as a criterion, if the mean square error obtained by inversion is less than a set convergence value or a set number of inversions is reached, ending the inversion, outputting the model parameters obtained at that point, obtaining a temperature distribution by forward calculation; if the mean square error is greater than the set value and the set number of inversions is not reached, continuing to perform inversion steps;
based on a reference model constraint and the model parameters in a current inversion, solving the inversion equation to obtain the model parameter vector change;
obtaining new model parameters, returning to the step of using the finite difference method for simulation calculation to perform a next generation iterative inversion.

9. A geological advance detection system for high-temperature heat damage in a tunnel based on thermal source inversion, comprising:
a first acquisition system configured to measure a rock mass internal temperature in advance boreholes arranged in preliminarily determined high temperature anomalous sections;
a second acquisition system configured to obtain scanning results of an apparent temperature of a tunnel surrounding rock;
an inversion interpretation module configured to extract the two collected temperature data to form a new sequence, perform an inversion interpretation on the sequence, construct a three-dimensional (3D) thermal source inversion objective function based on a least squares method and an inversion equation, and solve the inversion equation;
an imaging analysis module configured to form, based on the solution results, a thermal source and temperature field image for high-temperature heat damage detection within a survey area, and combine with existing geology to analyze a temperature, a location, a scale, a type, and a heat damage level of the high-temperature heat damage.

10. The geological advance detection system according to claim 9, wherein the first acquisition system comprises a plurality of distributed optical fiber temperature measurement modules, each arranged in an advance borehole; and,
the second acquisition system is a scanning robot.
